(19) United States
(12) Patent Application Publication
(10) Pub. No.: US 2004/0071538 A1
(43) Pub. Date: Apr. 15, 2004

(54) EZ-DZ motorized log dolly

(76) Inventor: Donald Edward Musfeldt, Yulee, FL (US)

Correspondence Address: DONALD E. MUSFELDT, 633 BROOKE STREET, YULEE, FL, 32097, US

(21) Appl. No.: 10/270,772

(22) Filed: Oct. 11, 2002

(51) Int. Cl. B66F 19/00

(52) U.S. Cl. 414/555

(57) ABSTRACT

A 2 cycle gasoline engine powering a two (2) wheeled dolly with a differential transaxle, braking system, finger trottlr, six(6) forward gears and one (1) reverse gear, capable of carring heavy loads of logs and or limbs comfortably by one person once loaded from a confined location, through standard fence gates and all terrains including steep inclines, to an area of which the logs and or limbs can then be loaded onto a loader truck to be disposed of. A tripod type boom with log tongs is an attachment meant to assist in removing smaller debris.

### BRIEF SUMMARY OF THE INVENTION

The invention of this motorized log dolly, relatively a 2 cycle engine powered dolly or hand cart, will help to remove logs and limbs of a downed problematic tree from a confined area.

### BACKGROUND OF THE INVENTION

Prior to the invention of the motorized log dolly, it was customary to have an arborist or tree surgeon to cut down large trees that were located in close proximity to structures, fences and the like, as not to allow a loader truck near enough to remove the debris. The usually large and often awkward logs and limbs would have to be transfered manually by upto or in excess of five (5) persons, by lifting and maneuvering the peculiar logs or limbs onto a standard dolly or hand cart or transfering by hand from a close quartered location to where the debris could be loaded on to a truck for disposal. Most often the logs and limbs would have to be moved over rough terrain such as mud, sand and the like as well as up steep inclines. It has been shown that standard dollies, hand carts and wheel barrells are not easily managable with extremly heavy loads.

The invention oh this two (2) wheeled motorized log dolly will omit this pre-existing problem.

The motorized log dolly was invented for the primary use but not limited to the arborist and or tree removal industry.

### BRIEF DESCRIPTION OF DRAWINGS

Page 1 of 4 illustrates the left side view of the motorized log dolly in transporting position also showing where the boom attachment connects to dolly.

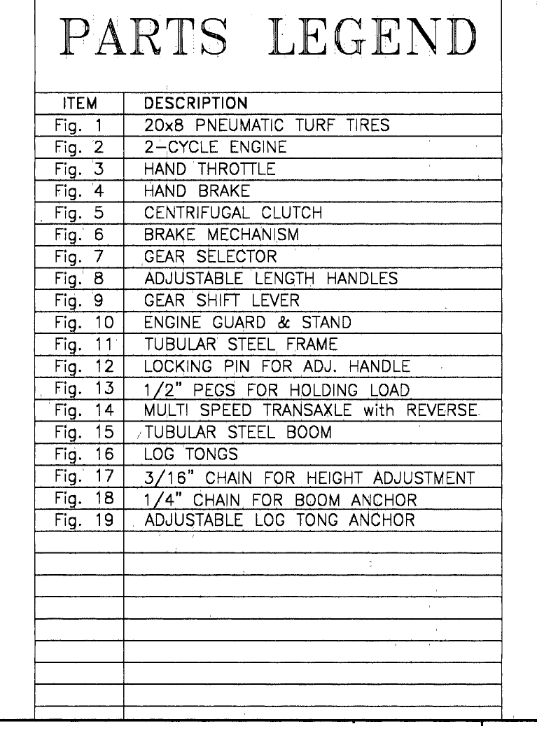

Page 2 of 4 illustrates a top view, left side view as well as a front view of the motorized log dolly showing FIGS. 1 through 14 which are listed as well as descriptions for each figure on page 4.

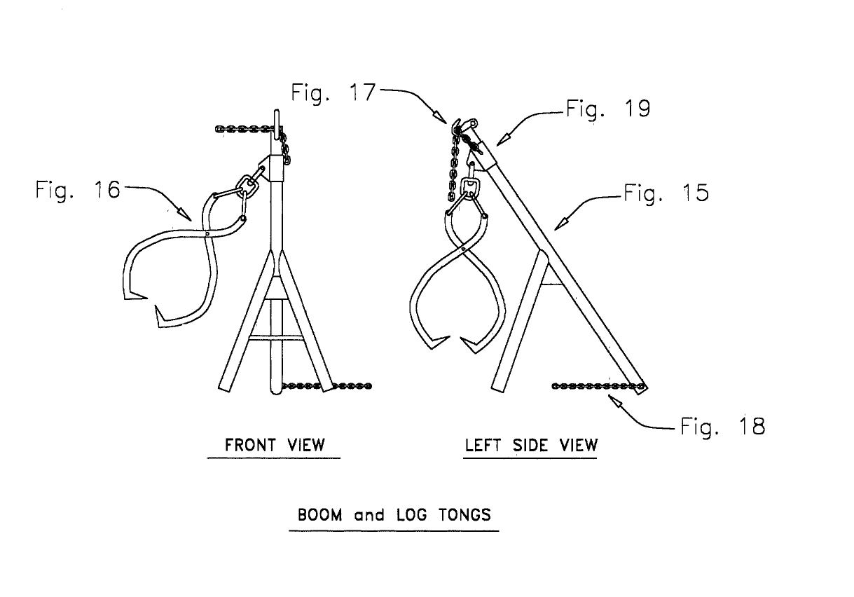

Page 3 of 4 illustrates a front view as well as a left side view of the motorized log dolly with the boom and log tongs mounted showing FIGS. 15 through 19 which are listed as well as descriptions for each figure on page 4.

Page 4 of 4 illustrates the above mentioned numeric list of all figures as well as a description of each figure.

### DETAILED DESCRIPTION OF THE INVENTION

In reference to page 1 of the drawings, the motorized log dolly with attachable boom with log tongs is designed utilizing the following method; Using a transaxle FIG. 14 with a quick change differential, belt driven rear end. Welded on either side of the mounting bracket bolted to rear end is a 2 inch in diameter by approximately 5 foot 1 inch long tubular steel pipe FIG. 11, welding three ½ inch tubular steel pipe 1 foot apart across the 5 foot 1 inch tubular steel pipe as to construct a frame for supporting the weight of the load. Depending on the circumference of the log cut and the length of the cut log, the motorized log dolly has the ability to support and transfer up to approximatly 600 pounds, estimated maximum weight limit. Easily managed by one operator over rough terrain and steep inclines.

Again, using a ½ inch tubular steel pipe, is formed to construct an engine guard FIG. 10 as it also doubles as a stand when the log dolly is laid down or dropped.

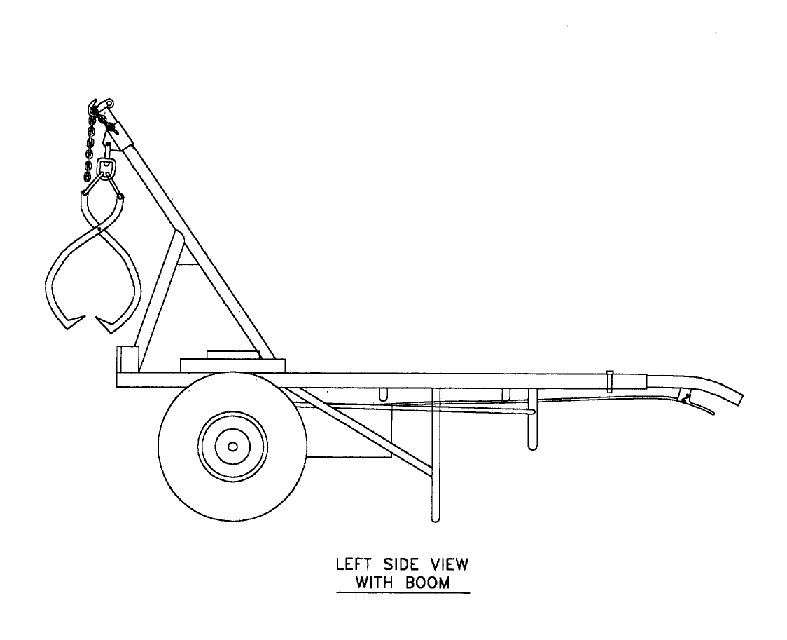

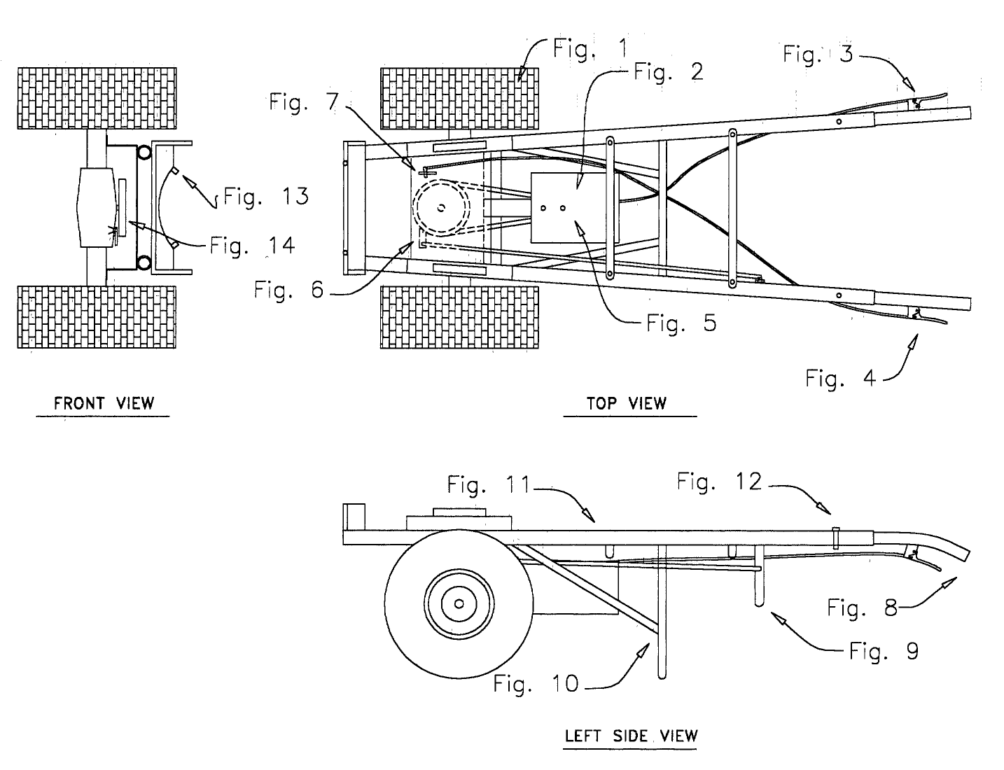

A two (2) cycle gasoline engine FIG. 2 is attached to the frame FIG. 11 by using a cut of chain saw bar, welded to a flat piece of steel approximatly 2 inches wide and 1 foot long that has been welded to the frame FIG. 11. The two (2) cycle gasoline engine FIG. 2 has a centrifugal clutch FIG. 5 from which the clutch housen is changed from a sprocket housen to a pully attaching a belt from the two (2) cucle engine FIG. 2 to the transaxle pully FIG. 14.

Constructing the brake system by attaching a brake cable to the brake system FIG. 6 on the transaxle to the left handle bar where as it is connected to the brake handle FIG. 4.

A ⅜ inch solid steel bar is connected to the shifting linkage on the transaxle to the shifting lever FIG. 9 on the left side of the frame, located between the engine guard and stand FIG. 10 and the brake handle FIG. 4 which consists of six (6) forward gears and one (1) reverse gear.

### DETAILED DESCRIPTION OF INVENTION CON'T

Handles are adjustable to 7 feet overall length to accomodate leverage FIG. 8, by adding 1¼ inch tubular steel pipe inside of the 2 inch by 5 foot 1 inch tubular steel pipe, drilling holes for height adjustment held in place either before or after extention by locking pin FIG. 12

FIG. 13 shows ½ inch pegs for holding the load securely in place once loaded. x

FIG. 1 shows 20 inch by 8 inch pneumatic turf tires attached to either end of transaxle.

The boom attachment is conformed of 1¼ inch in diameter by 36 inch long tubular steel pipe with two connecting 1¼ inch in diameter by by 16 inch long tubular steel pipe at the 18 inch mark of the 36 inch tubular steel pipe to create a tripod type boom which fits on the tounge of the dolly held in place by ½ inch by 2 inch steel pockets FIG. 15A 3/16 inch by 24 inch chain is used for height adjustment by wrapping around first brace on the dolly frame where a chain lock is mounted to secure height. The weight of the load holds the sides of the boom in the pockets, which is reinforced by a ¼ inch by 12 inch steel chain which is attached to a 4 inch by 2 inch piece of tubular steel pipe FIG. 19, connected to a set of log tongs which is adjustable by chain lock at desired position.

The boom is used in hauling smaller limbs or logs and the like in conjunction with the origanal invention of the motorized log dolly.

It is claimed that:

1. This motorized log dolly is used for the assistance in the removal of logs, limbs, and or other heavy and awkward loads.

2. A dolly which is powered by a 2 cycle engine with a multi-speed transaxle for use as stated in claim 1 consists of the following;
a tubular steel frame which has the capability to hold and transport an estimated 600 pounds;
said frame is mounted onto one multi-speed transaxle with reverse;
said frame houses the stated 2 cycle engine;
said 2 cycle engine has a centrifical clutch and utlizes a pully system to power said transaxle;
said multi-speed transaxle embodies six(6) forward gears and one (1) reverse gear;
said dolly has one pair of pnuematic turf tires mounted on either side of transaxle, supporting said tubular steel frame, engine and load.

3. A motorized log dolly as claimed in claim 2, also includes extendable handle bars intended for assistance in the leverage of the load.

4. This motorized log dolly can be modified or altered to accommodate other heavy or awkward materials such as cylinders and large nursery plants.

5. Attachments such as a trailer hitch can be used to maneuver small utility trailers, boat trailers and the like.

6. Operator can either walk behind dolly or can pull dolly behind him or her.

7. Dolly can be modified or altered to be battery powered for use indoors, as in warehouses or large department stores.

8. The tripod type boom with log tongs can also be used in conjunction with log dolly to carry more load.

9. Consequently, the invention and the use of said motorized log dolly has the capability and in all probability to save man hours, allowing companies to complete more jobs in less time thus, saving on overhead.
